(19) United States
(12) Patent Application Publication
(10) Pub. No.: US 2024/0394614 A1
(43) Pub. Date: Nov. 28, 2024

(54) INTEGRATING VOLUNTEERING WITH AUTONOMOUS VEHICLE OPERATIONS

(71) Applicant: GM Cruise Holdings LLC, San Francisco, CA (US)

(72) Inventors: Jennifer Devar McKnew, Petaluma, CA (US); Alexander Willem Gerrese, San Francisco, CA (US); Spencer Lee James, Santa Clara, CA (US)

(73) Assignee: GM Cruise Holdings LLC, San Francisco, CA (US)

(21) Appl. No.: 18/322,731

(22) Filed: May 24, 2023

(51) Int. Cl. G06Q 10/0631

(52) U.S. Cl. CPC G06Q 10/06311

(57) ABSTRACT

A volunteering platform facilitates voluntary activities associated with AV rides. The platform may receive a request for AV service from a first user and an offer to assist other users from a second user. The platform may determine whether an assistance to be provided by the second user can facilitate the service to be received by the first user. After determining that the assistance to be provided by the second user can facilitate the service to be received by the first user, the platform may pair the first user with the second user. The platform may select an AV from a fleet of AVs to serve the request from the first user with the assistance from the second user. The platform may plan an operation of the AV based on the request from the first user and the offer from the second user. The platform can dispatch the AV.

### TECHNICAL FIELD OF THE DISCLOSURE

The present disclosure relates generally to autonomous vehicles (AVs) and, more specifically, to integrating volunteering with AV operations.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs that can provide services to users, according to some embodiments of the present disclosure;

FIG. 2 is a block diagram showing a fleet management system, according to some embodiments of the present disclosure;

FIG. 3 is a block diagram showing a vehicle manager, according to some embodiments of the present disclosure;

FIG. 4 is a block diagram showing a sensor suite, according to some embodiments of the present disclosure;

FIG. 5 is a block diagram showing an onboard computer, according to some embodiments of the present disclosure; and

FIG. 6 is a flowchart showing a method of integrating volunteering with AV operations, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

AVs can provide driverless services, such as ride services, delivery services, and so on. A person can request an AV to pick him/her up from a location and drop him/her off at another location. With the autonomous driving features of the AV, the person does not have to drive during the ride and can be a passenger of the AV. The AV can navigate from the pick-up location to the drop-off location with no or little user input. AVs can provide other driverless services too, such as delivery service. A person can request an AV to deliver one or more items from one location to another location, and the person does not have to drive or be a passenger of the AV for the delivery.

Some AV services can benefit from human assistance. For example, people who have certain skill sets or capabilities may need human assistance to get on or off AVs. As another example, people who have difficulty with carrying items can benefit from other people carrying the delivered items from the AV drop-off locations to their desired locations. There can be people who would like to provide such assistance, such as people who want to give free time and labor to assist. Also, many people may want to donate money or free AV mileage so that others (e.g., people who have financial needs) can get AV services for free. Further, driverless operations of AVs can help people with donation of goods (e.g., food, medicine, furniture, toy, or even blood). For instance, AVs can deliver donated items from donors to recipients or provide driverless blood drives.

Embodiments of the present disclosure provide a volunteering platform that can integrate volunteering with AV driverless operations. In various embodiments of the present disclosure, the volunteering platform may be associated with a fleet of one or more AVs (“AV fleet”). The volunteering platform receives services requests and assistance offers. A service request is a request from a user for a service to be provided by the AV fleet, such as ride service, delivery service, and so on. An assistance offer is an offer of a user to assist. The assistance offer may indicate the user's offer of one or more types of assistance, such as labor-based assistance (e.g., assistance with carrying items, assistance with getting on or off AVs, etc.), financial assistance (e.g., donating money, donating AV mileage for free AV services, offering share of AV rides for free, etc.), goods-based assistance (e.g., giving food, medicine, furniture, toy, blood, etc.), other types of assistance, or some combination thereof. A user making a service request or assistance offer may be an individual, a group of people, or an organization (e.g., a blood drive organization, food bank, etc.).

The volunteering platform may pair a service request with one or more assistance offers by determining whether the offered assistance can facilitate the requested service, e.g., whether a user requesting the service can benefit from the offered assistance in the process of receiving the requested service. For instance, the volunteering platform may determine whether the type of assistance that would help with the user requesting the service matches the type of assistance offered by the user making the assistance offer. The volunteering platform may also pair a service request with an assistance offer based on temporal information (e.g., start time, end time, duration of time, etc.), spatial information (e.g., pick-up location, drop-off location, distance, etc.), or other information associated with the service request or assistance offer.

After paring a service request with one or more assistance offers, the volunteering platform may select an AV based on the service request and assistance offer. For instance, the volunteering platform may select an AV that is available given the temporal information or spatial information associated with the service request or assistance offer. The volunteering platform may also determine whether an AV has the function (or functions, such as hardware component, software function, space, etc.) that would be needed to support the requested service or offered assistance. The volunteering platform may also plan the operation of the selected AV, e.g., by determining the operation times and navigation route of the AV based on the service request and assistance offer. The volunteering platform may dispatch the AV to perform the requested service and to support the offered assistance.

As will be appreciated by one skilled in the art, aspects of the present disclosure, in particular aspects of the volunteering platform, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

Example System with AV Fleet

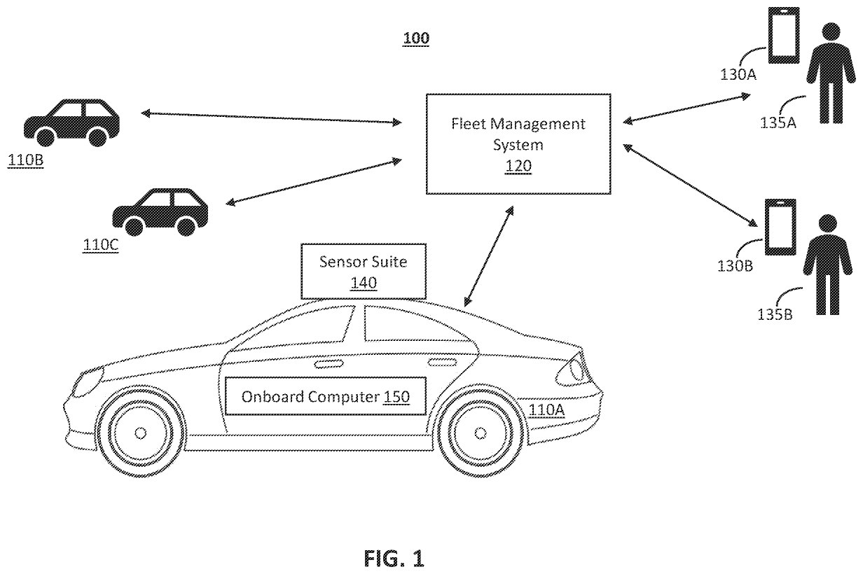

FIG. 1 illustrates a system 100 including a fleet of AVs that can provide services to users, according to some embodiments of the present disclosure. The system 100 includes AVs 110A-110C (collectively referred to as “AVs 110” or “AV 110”), a fleet management system 120, and client devices 130A and 130B (collectively referred to as “client devices 130” or “client device 130”). The client devices 130A and 130B are associated with users 135A and 135B, respectively. The AV 110A includes a sensor suite 140 and an onboard computer 150. Even though not shown in FIG. 1, the AV 110B or 110C can also include a sensor suite 140 and an onboard computer 150. In other embodiments, the system 100 may include more, fewer, or different components. For example, the fleet of AVs 110 may include a different number of AVs 110 or a different number of client devices 130.

The fleet management system 120 manages the fleet of AVs 110. The fleet management system 120 may manage one or more services that the fleet of AVs 110 provides to the users 135. An example service is a ride service, e.g., an AV 110 provides a ride to a user 135 from a first location to a second location. Another example service is a delivery service, e.g., an AV 110 delivers one or more items from or to the user 135. The fleet management system 120 can select one or more AVs 110 (e.g., AV 110A) to perform a particular service, and instructs the selected AV to drive to one or more particular locations associated with the service (e.g., a first address to pick up user 135A, and a second address to pick up user 135B). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a network, such as the Internet.

In some embodiments, the fleet management system 120 receives service requests for the AVs 110 from the client devices 130. In an example, the user 135A accesses an app executing on the client device 130A and requests a ride from a pickup location (e.g., the current location of the client device 130A) to a destination location. The client device 130A transmits the ride request to the fleet management system 120. The fleet management system 120 selects an AV 110 from the fleet of AVs 110 and dispatches the selected AV 110A to the pickup location to carry out the ride request. In some embodiments, the ride request further includes a number of passengers in the group. In some embodiments, the ride request indicates whether a user 135 is interested in a shared ride with another user travelling in the same direction or along a same portion of a route. The ride request, or settings previously entered by the user 135, may further indicate whether the user 135 is interested in interaction with another passenger.

In some embodiments, the fleet management system 120 provides a volunteering platform for integrating volunteering with AV services. The fleet management system 120 may allow users 135 to submit offers to assist, such as offers to assist other people to ride AVs 110 (e.g., help AV passengers with certain skill sets or capabilities to get on and off AVs 110), offers to assist with item delivery (e.g., help with carrying items from stores to pick-up locations or from drop-off locations to people's homes, etc.), offers to provide free AV services (e.g., give money, give AV mileage, allow other people to share AV rides for free, etc.), and so on. The fleet management system 120 may pair assistance offers with requested services that can be facilitated by such assistance offers. After paring an assistance offer and a service request, the fleet management system 120 can select an AV and plan an operation of the AV based on the assistance offer and the service request.

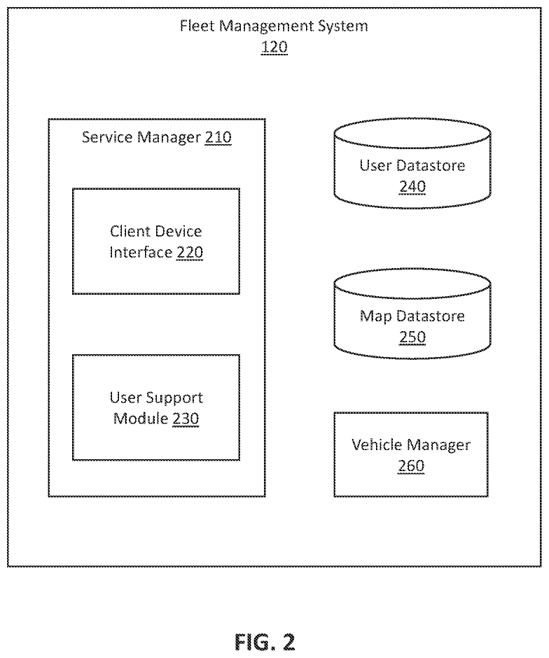

The fleet management system 120 may provide the AVs 110 information for navigating the AVs 110 during the operations of the AVs. For instance, the fleet management system 120 may provide maps (e.g., semantic maps, vector maps, etc.) of environments where AVs operate. The fleet management system 120 may also facilitate AVs to model restricted traffic zones for the AVs to safely navigate through or pass the restricted traffic zones. Certain aspects of the fleet management system 120 are described further in relation to FIG. 2.

A client device 130 is a device capable of communicating with the fleet management system 120, e.g., via one or more networks. The client device 130 can transmit data to the fleet management system 120 and receive data from the fleet management system 120. The client device 130 can also receive user input and provide output. In some embodiments, outputs of the client devices 130 are in human-perceptible forms, such as text, graphics, audio, video, and so on. The client device 130 may include various output components, such as monitors, speakers, headphones, projectors, and so on. The client device 130 may be a desktop or a laptop computer, a smartphone, a mobile telephone, a personal digital assistant (PDA), or another suitable device.

In some embodiments, a client device 130 executes an application allowing a user 135 of the client device 130 to interact with the fleet management system 120. The application may include codes provided by the fleet management system 120. For example, a client device 130 executes a browser application to enable interaction between the client device 130 and the fleet management system 120 via a network. In another embodiment, a client device 130 interacts with the fleet management system 120 through an application programming interface (API) running on a native operating system of the client device 130, such as IOS® or ANDROID™. The application may be provided and maintained by the fleet management system 120. The fleet management system 120 may also update the application and provide the update to the client device 130. In some embodiments, the application may be downloaded from the fleet management system 120 and installed on the client device 130.

In some embodiments, a user 135 may submit service requests to the fleet management system 120 through a client device 130. A client device 130 may provide its user 135 a user interface (UI), through which the user 135 can make service requests, such as ride request (e.g., a request to pick up a person from a pickup location and drop off the person at a destination location), delivery request (e.g., a request to delivery one or more items from a location to another location), and so on. The UI may allow users 135 to provide locations (e.g., pickup location, destination location, etc.) or other information that would be needed by AVs 110 to provide services requested by the users 135. The UI may also allow a user 135 to indicate that the user 135 can benefit from human assistance in the process of receiving the requested service. For example, the user 135 may indicate that the user 135 needs help with carrying items or getting on/off AVs 110 due to one or more skill sets or capabilities of the user 135. As another example, the user 135 may indicate that the user 135 is open to receiving donations.

A user 135 may also submit assistance offers to the fleet management system 120 through a client device 130. A client device 130 may provide its user 135 a UI, through which users 135 can make assistance offers. The UI may allow a user 135 to specify the type(s) of assistance the user 135 is willing to provide. The UI may also allow the user 135 to specify one or more times or one or more locations that the user 135 will be available to help. For assistance offers related to donations, the UI may allow the user 135 to submit descriptions of the substance that the user 135 wants to donate. In some embodiments, the UI may be the same UI through which users 135 can make service requests. In other embodiments, the UI for making assistance offers may be separate from the UI for making service requests. In some embodiments, the UI for making service requests or assistance offers may be facilitated by the fleet management system 120.

The client device 130 may provide the user 135 an UI through which the user 135 can interact with the AV 110 that provides a ride to the user 135. The AV 110 may transmit one or more messages to the UI. The messages may be associated with one or more behaviors performed by the AV 110 for providing the ride to the user 135. The user 135 may view the messages in the UI. The UI may also allow the user 135 to interact with the messages. In some embodiments, the UI allows the user 135 to provide a comment or rate on the AV behaviors or the ride. The UI may also allow the user 135 to modify one or more settings of the ride in light of the AV behaviors.

The client device 130 may also provide the user 135 an UI through which the user 135 can interact with the fleet management system 120. For instance, the UI enables the user to submit a request for assistance to the fleet management system 120 through a network or a telephone service (e.g., a customer service hotline). The UI can further facilitate a communication between the user 135 and an agent of the fleet management system 120 who can provide the requested assistance. The UI may further enable the user to comment on or rate the agent.

The AV 110 is preferably a fully autonomous automobile, but may additionally or alternatively be any semi-autonomous or fully autonomous vehicle, e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

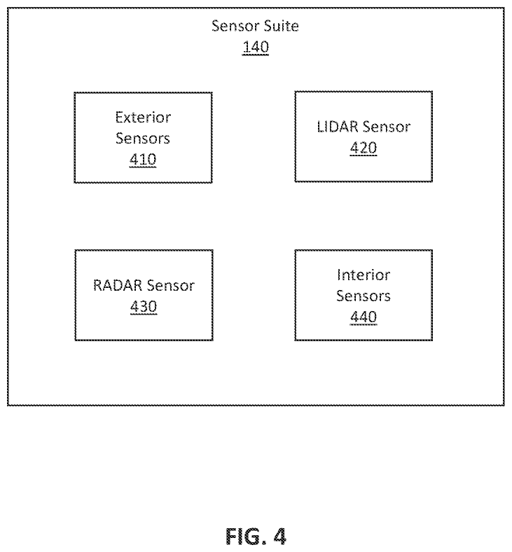

The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUs), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 4.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls the behavior of the AV 110. The onboard computer 150 may be preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

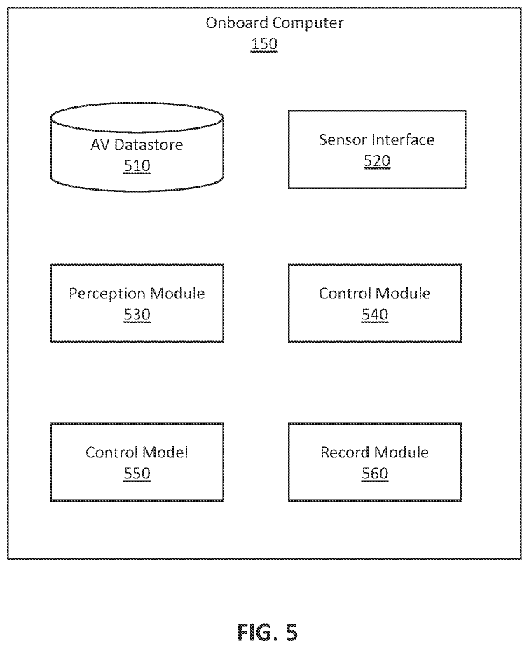

In some embodiments, the onboard computer 150 is in communication with the fleet management system 120, e.g., through a network. The onboard computer 150 may receive instructions from the fleet management system 120 and control behavior of the AV 110 based on the instructions. For example, the onboard computer 150 may receive from the fleet management system 120 an instruction for providing a ride to a user 135. The instruction may include information of the ride (e.g., pickup location, drop-off location, intermediate stops, etc.), information of the user 135 (e.g., identifying information of the user 135, contact information of the user 135, etc.). The onboard computer 150 may determine a navigation route of the AV 110 based on the instruction. As another example, the onboard computer 150 may receive from the fleet management system 120 a request for sensor data to be used by the ride evaluation platform. The onboard computer 150 may control one or more sensors of the sensor suite 140 to detect the user 135, the AV 110, or an environment surrounding the AV 110 based on the instruction and further provide the sensor data from the sensor suite 140 to the fleet management system 120. The onboard computer 150 may transmit other information requested by the fleet management system 120, such as perception of the AV 110 that is determined by a perception module of the onboard computer 150, historical data of the AV 110, and so on. Certain aspects of the onboard computer 150 are described further in relation to FIG. 5.

### Example Fleet Management System

FIG. 2 is a block diagram showing the fleet management system, according to some embodiments of the present disclosure. The fleet management system 120 includes a service manager 210, a user datastore 240, a map datastore 250, and a vehicle manager 260. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 150.

The service manager 210 manages services that the fleet of AVs 110 can provide. The service manager 210 includes a client device interface 220 and a user support module 230. The client device interface 220 provides interfaces to client devices, such as headsets, smartphones, tablets, computers, and so on. For example, the client device interface 220 may provide one or more apps or browser-based interfaces that can be accessed by users, such as the users 135, using client devices, such as the client devices 130. The client device interface 220 enables the users to submit requests to a ride service provided or enabled by the fleet management system 120. In particular, the client device interface 220 enables a user to submit a ride request that includes an origin (or pickup) location and a destination (or drop-off) location. The ride request may include additional information, such as a number of passengers travelling with the user, and whether or not the user is interested in a shared ride with one or more other passengers not known to the user.

The client device interface 220 can also enable users to select ride settings. The client device interface 220 may enable a user to opt-in to some, all, or none of the virtual activities offered by the ride service provider. The client device interface 220 may further enable the user to opt-in to certain monitoring features, e.g., to opt-in to have the interior sensors 440 obtain sensor data of the user. The client device interface 220 may explain how this data is used by the service manager 210 (e.g., for providing support to the user, etc.) and may enable users to selectively opt-in to certain monitoring features, or to opt-out of all of the monitoring features. In some embodiments, the user support platform may provide a modified version of a virtual activity if a user has opted out of some or all of the monitoring features.

The user support module 230 may receive support requests from passengers of AVs through the client device interface 220 or the onboard computer 150. The user support module 230 manages the support requests. In some embodiments, the user support module 230 maintains a queue of pending support requests, in which the pending support requests may be arranged in an order. A pending support request is a support request that has not been completed. A support request may be considered completed after the support requested by the passenger has been provided or the issue that triggered the support request has been resolved.

The user support module 230 may assign the pending support requests to agents based on the order in the queue. The agent can interact with the passenger and provide support to the passenger. An agent may be associated with a device in communication with the user support module 230. The device may be a desktop or a laptop computer, a smartphone, a mobile telephone, a PDA, or another suitable device. The user support module 230 may send information related to support requests assigned to the agent to the agent's device. The information may include the support requests and guidance on how to provide the requested support.

In some embodiments, the user support module 230 determines a state (e.g., a sentiment) of a passenger who submitted a support request and processes the support request based on the passenger's state. The user support module 230 may determine the passenger's state based on data of the passenger, data of the AV, data of one or more objects in an environment surrounding the passenger or AV, or some combination thereof. The data may include sensor data generated by the sensor suite 140 from detecting the passenger, AV, one or more objects in the environment, or some combination thereof. For instance, the user support module 230 may interface with AVs 110 (e.g., with onboard computers of the AVs 110) and receive sensor data from the AVs 110. The sensor data may be camera images, captured sound, measured temperature, other outputs from the sensor suite 140, or some combination thereof. The data may also include data retrieved by the user support module 230 from the user datastore 240 or map datastore 250. In an embodiment, the user support module 230 may provide the data to a trained model and the train model analyzes the sentiment of the passenger. The trained model may classify the passenger's sentiment. Example categories include negative (e.g., anxious, angry, etc.), neural (e.g., calm), positive (e.g., confident, happy, etc.), and so on. The trained model may also estimate a degree of the passenger's sentiment, such as an anxiety level or anger level.

The user support module 230 may assign the support request to an agent based on the passenger's state. For instance, based on a determination that the passenger is anxious, the user support module 230 may assign the support request to a currently available agent or the next available agent so that the waiting time of the passenger can be minimized. The agent, who receives the support request, can help the passenger to deal with the issue. The agent may communicate with the passenger, e.g., through an audio or video call.

The user datastore 240 stores information associated with users of the fleet management system 120, including users requesting AV services and users offering voluntary assistance. A user may be an individual, a group of individuals, or an entity (e.g., business, organization, etc.). The information associated with a user may be stored as a user profile. A user profile may include information describing one or more attributes of the user. Examples of information stored in a user profile include biographic, demographic, and other types of descriptive information, such as work experience, educational history, gender, hobbies or preferences, location and the like. A user profile may include declarative information about the user that was explicitly shared by the user or information inferred by the fleet management system 120. A user profile may also store other information provided by the user, such as audio, images, videos, and so on.

A user profile may also maintain references to services requested by the user or assistance offered by the user. An example user profile may include information indicating a user's need for voluntary assistance, such as information indicating one or more skill sets, capabilities, and so on. The information may be provided by the user, e.g., through the client device interface 220, or inferred by another component of the fleet management system 120, e.g., by the vehicle manager 260. The user profile may further include information associated with services that have been, are being received, or will be received by the user and facilitated by voluntary assistance. Another example user profile may include information indicating a user's will to assist, such as information about donations made by the user. The information may be provided by the user, e.g., through the client device interface 220, or inferred by another component of the fleet management system 120, e.g., by the vehicle manager 260. The user profile may further include information associated with services that have been, are being received, or will be facilitated by the user's assistance.

The user datastore 240 may also store ride information associated with users of the ride service, e.g., the users 135. The user datastore 240 may store an origin location and a destination location for a user's current ride. The user datastore 240 may also store historical ride data for a user, including origin and destination locations, dates, and times of previous rides taken by a user. The historical data of the user may also include information associated with historical support requests made by the user during the previous rides, such as sensor data associated with the historical support requests, communications of the user with agents that serviced the historical support requests, states of the user during the communications, information of AVs 110 associated with the historical support requests, and so on. The historical data of the user may also include information associated with communications of AVs with the user for AV behaviors in historical rides taken by the user. In some cases, the user datastore 240 may further store future ride data, e.g., origin and destination locations, dates, and times of planned rides that a user has scheduled with the ride service provided by the AVs 110 and fleet management system 120. Some or all of the data of a user in the user datastore 240 may be received through the client device interface 220, an onboard computer (e.g., the onboard computer 150), a sensor suite of AVs 110 (e.g., the sensor suite 140), a third-party system associated with the user and the fleet management system 120, or other systems or devices.

In some embodiments, the user datastore 240 also stores data indicating user preferences associated with rides in AVs. The fleet management system 120 may include one or more learning modules (not shown in FIG. 2) to learn user interests based on user data. For example, a learning module may compare locations in the user datastore 240 with map datastore 250 to identify places the user has visited or plans to visit. For example, the learning module may compare an origin or destination address for a user in the user datastore 240 to an entry in the map datastore 250 that describes a building at that address. The map datastore 250 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user datastore 240. As another example, a learning module may learn user tolerance or preference for AV behaviors, e.g., based on information associated with communications of AVs with the user for AV behaviors in historical rides taken by the user. The learning module may learn that the user has a high tolerance for an AV behavior based on information indicating that the user had no bad feelings for the AV behavior undesirable in one or more previous rides. Similarly, the learning module may learn that the user has a low tolerance for a type of AV behavior based on information indicating that the user had negative sentiments towards the AV behavior in one or more previous rides.

The map datastore 250 stores one or more maps of environments through which the AVs 110 may travel. A map may be a semantic map or vector map. The map datastore 250 includes data describing roadways, such as e.g., locations of roadways, connections between roadways, roadway names, speed limits, traffic flow regulations, toll information, etc. The map datastore 250 may further include data describing buildings (e.g., locations of buildings, building geometry, building types), and data describing other objects (e.g., location, geometry, object type) that may be in the environments of AV 110. The map datastore 250 may also include data describing other features, such as bike lanes, sidewalks, crosswalks, traffic lights, parking lots, signs, billboards, etc.

Some of the map datastore 250 may be gathered by the fleet of AVs 110. For example, images obtained by the exterior sensors 410 of the AVs 110 may be used to learn information about the AVs' environments. As one example, AVs may capture images in a residential neighborhood during a winter holiday season, and the images may be processed to identify which homes have winter holiday decorations. The images may be processed to identify particular features in the environment. For the winter holiday decoration example, such features may include light color, light design (e.g., lights on trees, roof icicles, etc.), types of blow-up figures, etc. The fleet management system 120 and/or AVs 110 may have one or more image processing modules to identify features in the captured images or other sensor data. This feature data may be stored in the map datastore 250. In some embodiments, certain feature data (e.g., seasonal data, such as winter holiday decorations, or other features that are expected to be temporary) may expire after a certain period of time. In some embodiments, data captured by a second AV 110 may indicate that a previously-observed feature is no longer present (e.g., a blow-up figure has been removed) and in response, the fleet management system 120 may remove this feature from the map datastore 250.

The vehicle manager 260 manages and communicates with the fleet of AVs 110. The vehicle manager 260 assigns the AVs 110 to various tasks and directs the movements of the AVs 110 in the fleet. In some embodiments, the vehicle manager 260 includes additional functionalities not specifically shown in FIG. 2. For example, the vehicle manager 260 instructs AVs 110 to drive to other locations while not servicing a user, e.g., to improve geographic distribution of the fleet, to anticipate demand at particular locations, etc. The vehicle manager 260 may also instruct AVs 110 to return to an AV 110 facility for fueling, inspection, maintenance, or storage. As another example, the vehicle manager 260 may include functionalities of the onboard computer 150, such as functionalities related to modeling restricted traffic zones.

The vehicle manager 260 can integrate AV tasks with volunteering. The vehicle manager 260 allows users to receive voluntary assistance in the process of receiving services by the fleet of AVs 110. In an example, users may receive free rides or free delivery services by the fleet of AVs 110 by using money or AV mileage donated by other users. In another example, users may receive goods donated by other users that are delivered by the fleet of AVs 110. In yet another example, users, who have one or more skill sets or capabilities, may receive help from other users before, during, or after their AV rides. The vehicle manager 260 can pair users willing to help with users needing the help and plan AV tasks accordingly.

In some embodiments, the vehicle manager 260 selects AVs from the fleet to perform various tasks and instructs the AVs to perform the tasks. For example, the vehicle manager 260 receives a ride request from the client device interface 220. The vehicle manager 260 selects an AV 110 to service the ride request based on the information provided in the ride request, e.g., the origin and destination locations. If multiple AVs 110 in the AV 110 fleet are suitable for servicing the ride request, the vehicle manager 260 may match users for shared rides based on an expected compatibility. For example, the vehicle manager 260 may match users with similar user interests, e.g., as indicated by the user datastore 240. In some embodiments, the vehicle manager 260 may match users for shared rides based on previously-observed compatibility or incompatibility when the users had previously shared a ride.

The vehicle manager 260 or another system may maintain or access data describing each of the AVs in the fleet of AVs 110, including current location, service status (e.g., whether the AV 110 is available or performing a service, when the AV 110 is expected to become available, whether the AV 110 is schedule for future service, etc.), fuel or battery level, and so on. The vehicle manager 260 may select AVs for service in a manner that optimizes one or more additional factors, including fleet distribution, fleet utilization, and energy consumption. The vehicle manager 260 may interface with one or more predictive algorithms that project future service requests and/or vehicle use, and select vehicles for services based on the projections.

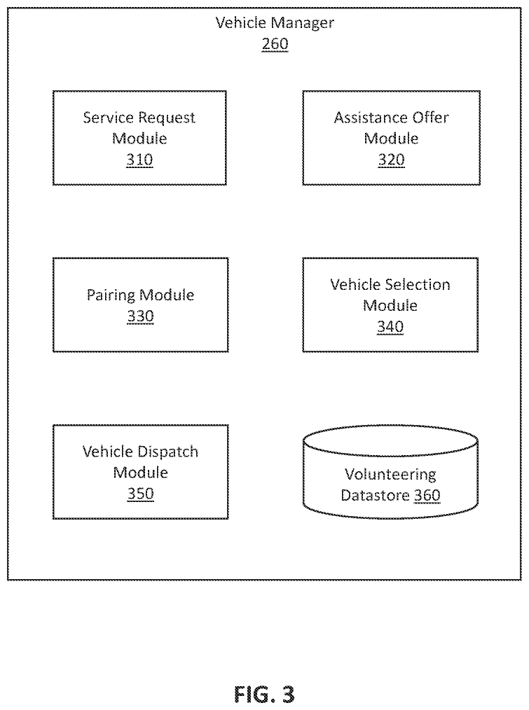

The vehicle manager 260 transmits instructions dispatching the selected AVs. In particular, the vehicle manager 260 instructs a selected AV 110 to drive autonomously to a pickup location in the ride request and to pick up the user and, in some cases, to drive autonomously to a second pickup location in a second ride request to pick up a second user. The vehicle manager 260 may dispatch the same AV 110 to pick up additional users at their pickup locations, e.g., the AV 110 may simultaneously provide rides to three, four, or more users. The vehicle manager 260 further instructs the AV 110 to drive autonomously to the respective destination locations of the users. Certain aspects of the vehicle manager 260 are described below in conjunction with FIG. 3.

FIG. 3 is a block diagram showing the vehicle manager 260, according to some embodiments of the present disclosure. The vehicle manager 260 includes a service request module 310, an assistance offer module 320, a pairing module 330, a vehicle selection module 340, a vehicle dispatch module 350, and a volunteering datastore 360. In alternative configurations, different and/or additional components may be included in the vehicle manager 260. Further, functionality attributed to one component of the vehicle manager 260 may be accomplished by a different component included in the vehicle manager 260, a different component in the fleet management system 120, the onboard computer 150, or a different system or device. For instance, the volunteering datastore 360 may be part of the user datastore 240 in FIG. 2.

The service request module 310 processes service requests from users. A service request is a request for a service to be provided by one or more AVs. The requested service may be a ride service, delivery service, or other types of service. The service request module 310 may receive a user's service request from the service manager 210, e.g., the client device interface 220 in the service manager 210. In some embodiments, the service request module 310 may determine whether human assistance (e.g., voluntary assistance from one or more other users) can facilitate the service that the user requested. Human assistance may be labor-based assistance (e.g., assistance with carrying items, assistance with getting on or off AVs, etc.), financial assistance (e.g., offering money, offering free AV services, etc.), good assistance (e.g., providing food, medicine, furniture, toy, blood, etc.), other types of assistance, or some combination thereof.

The service request module 310 may make the determination based on information in the service request. In an example, the service request may indicate that human assistance can help fulfill the user's need, such as the need that triggered the user to request the service. For example, the user may specify in the service request that the user would like one or more items to be delivered to the front door of the user's house as the user is incapable of carrying the items (e.g., due to one or more skill sets, capabilities, etc.). In another example, the service request may indicate that the user requests or prefers to receive human assistance or that the user does not refuse to receive human assistance.

In addition or alternative to the servicer request, the service request module 310 may determine whether human assistance can facilitate the user's service request based on a user profile associated with the user. The service request module 310 may retrieve the user profile from the user datastore 240. The user profile may indicate that the user could benefit from human assistance for AV services requested by the user. For example, the user profile may indicate that the user has one or more skill sets or capabilities, due to which the use may need human assistance for AV services. The service request module 310 may determine that human assistance may help the user with a ride or item delivery by an AV. As another example, the user profile may indicate that the user is a volunteer organization that can organize volunteering activities.

In some embodiments, after determining that a service request may be facilitated by human assistance, the service request module 310 may determine the category (or categories) of the human assistance that can facilitate the service request. In an example, the service request module 310 may select the category of the human assistance from a group of candidate categories that includes labor-based assistance, financial assistance, goods assistance, or other types of assistance.

The service request module 310 may determine temporal information associated with the service request, such as a time when the human assistance should start, a time when the human assistance should end, a duration of time of the human assistance, and so on. Additionally or alternatively, the service request module 310 may determine spatial information associated with the service request, such as a location where the human assistance should start, a location where the human assistance should end, a distance (or distance range) for which the human assistance is needed, and so on. The service request module 310 may determine temporal information or spatial information associated with the service request based on information in the service request (e.g., pick-up location, drop-off location, timestamps associated with the requested service, etc.), the user profile associated with the user making the service request, other information, or some combination thereof.

The service request module 310 may store the service request in the volunteering datastore 360. A service request stored in the volunteering datastore 360 may be associate with the category of the service request as well as temporal information, spatial information, or other information about the service request that is determined by the service request module 310.

The assistance offer module 320 processes assistance offers from users. The assistance offer module 320 may receive a user's assistance offer from the service manager 210, e.g., the client device interface 220 in the service manager 210. An assistance offer is an offer to provide assistance, such as labor-based assistance (e.g., assistance with carrying items, assistance with getting on or off AVs, etc.), financial assistance (e.g., offering money, offering free AV services, etc.), goods assistance, other types of assistance, or some combination thereof.

The assistance offer module 320 may classify assistance offers, e.g., by determining a category of assistance that the users are willing to provide. In some embodiments, the assistance offer module 320 may classify an assistance offer based on information in the assistance offer. For instance, the assistance offer may specify the type of assistance that the user is willing to provide, and the assistance offer module 320 can classify an assistance offer based on the specification. Additionally or alternatively, the assistance offer module 320 may classify an assistance offer based on a user profile associated with the user. The assistance offer module 320 may retrieve the user profile from the user datastore 240. The user profile may indicate the type of assistance that the user can provide. For example, the user profile may indicate that the user has signed up for providing labor-based assistance, financial assistance, goods assistance, or other types of assistance. The assistance offer module 320 may store assistance offers in the volunteering datastore 360. An assistance offer may be associated with a classification label determined by the assistance offer.

In some embodiments, the assistance offer module 320 may classify assistance offers by using a machine learning model. The assistance offer module 320 may information associated with an assistance offer (e.g., information in the assistance offer, user profile of the user making the assistance offer, etc.) into the machine learning model, and the machine learning model outputs a classification of the assistance offer. The assistance offer module 320 may include or be associated with a training module that trains the model with machine learning techniques. As part of the generation of the model, the training module may form a training set. The training set may include training samples and ground-truth labels of the training samples. A training sample may include information associated with an assistance offer. The training sample may have a ground-truth classification of the assistance offer, such as a verified or known classification of the assistance offer. The training module extracts feature values from the training set, the features being variables deemed potentially relevant to classification of assistance offers. In one embodiment, the training module applies dimensionality reduction (e.g., via linear discriminant analysis (LDA), principal component analysis (PCA), or the like) to reduce the amount of data in the feature vectors for ride services to a smaller, more representative set of data. The training module may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

The assistance offer module 320 may determine temporal information associated with the assistance offer, such as a time when the offered assistance can start, a time when the offered assistance can end, a duration of time of the offered assistance, and so on. Additionally or alternatively, the assistance offer module 320 may determine spatial information associated with the assistance offer, such as a location where the offered assistance can start, a location where the offered assistance can end, a location where the offered assistance can be provided, a distance limit of the offered assistance, and so on. The assistance offer module 320 may determine temporal information or spatial information associated with the assistance offer based on information in the assistance offer, the user profile associated with the user making the assistance offer, other information, or some combination thereof.

The assistance offer module 320 may store the assistance offer in the volunteering datastore 360. An assistance offer stored in the volunteering datastore 360 may be associate with classification information, temporal information, spatial information, or other information about the assistance offer that may be determined by the assistance offer module 320.

The pairing module 330 pair service requests with assistance offers. The pairing module 330 may pair a user who has made a service request with at least one other user who has made an assistance offer. To pair the users, the pairing module 330 may select the user making the assistance offer (and optionally one or more other users who have offered assistance) from a plurality of users who have offered to assist based on the service request (and optionally the assistance offer). Additionally or alternatively, the pairing module 330 may select one or more users who have offered assistance based on one or more attributes of the user requesting service. For instance, the pairing module 330 may select one or more volunteers from a pool of volunteers based on one or more skill sets or capabilities. As an example, the pairing module 330 may determine that the user requesting service has a need for a volunteer who has passed background screening. Based on such a determination, the pairing module 330 may select one or more volunteers who have passed background screening, e.g., based on information provided by the volunteers or other sources. In some embodiments, the pairing module 330 may select the user making the service request from a plurality of users who have requested services based on the assistance offer (and optionally the service request). In some embodiments, the pairing module 330 may pair the user making the service request with multiple users making assistance offers.

In some embodiments, the pairing module 330 may receive a request from the service request module 310 to pair a service request, which can be facilitated by human assistance, with one or more assistance offers. To pair a first user making a service request with a second user making an assistance offer (or paring the service request with the assistance offer), the pairing module 330 may determine that the offered assistance can facilitate the requested service based on information associated with the service request and information associated with the assistance offer. The pairing module 330 may receive information associated with the service request (e.g., classification information, temporal information, spatial information, etc.) from the service request module 310 or retrieve the information from the volunteering datastore 360 or the user datastore 240. Similarly, the pairing module 330 may receive information associated with the assistance offer (e.g., classification information, temporal information, spatial information, etc.) from the assistance offer module 320 or retrieve the information from the volunteering datastore 360 or the user datastore 240.

In some embodiments, the pairing module 330 may search for one or more assistance offers based on the information associated with the service request. The pairing module 330 identifies one or more assistance offers based on the category of the human assistance that can facilitate the service request. For instance, the pairing module 330 may identify assistance offer(s) that provide assistance falling into the same category as the human assistance that can facilitate the service request. In some embodiments, the pairing module 330 may determine to pair a service request with multiple assistance offers made by different users based on one or more attributes of the user requesting the service or one or more attributes of the requested service. For example, the pairing module 330 may pair the user requesting a delivery service with multiple volunteers offering to help with carrying items, after determining that multiple people are needed to carry the delivered item(s) given one or more attributes of the delivered item(s), such as size, weight, quantity, shape, packaging, or other attributes of the delivered items(s).

As another example, a service request may be a request for periodic AV operations, such as a request for a ride on every Tuesday, a request for food delivery on every Friday, etc. For a request for periodic service, the pairing module 330 may pair the service request with a user who has offered to provide periodic assistance, such as a user who has indicated that she/he would be available every Tuesday or Friday. Additionally or alternatively, the pairing module 330 may pair the service request with assistance offers made by a plurality of users, each of whom has offered to assist during the time of at least one AV operation for performing the service request.

In embodiments where the service request can be facilitated with human assistance in multiple categories, the pairing module 330 can identify one or more assistance offers for each of the categories. For example, the pairing module 330 may identify an assistance offer made by a volunteer who would like to help with carrying items for a delivery service request made by a user with one or more skill sets or capabilities. The pairing module 330 may also identify an assistance offer made by a donor who gives AV mileage for the delivery service request so that the user requesting the delivery service does not need to pay for the delivery service. As another example, the pairing module 330 may identify an assistance offer made by a blood donor who would like to give blood for a ride service request made by a blood donation organization. The pairing module 330 may also identify an assistance offer made by a donor who gives AV mileage for the ride service request so that neither the blood donor nor the blood donation organization needs to pay for the ride service.

In some embodiments, the pairing module 330 may also identify an assistance offer (or multiple assistance offers) for the service request based on the temporal information of the assistance offer and the temporal information of the service request. The pairing module 330 may determine whether the user making the assistance offer would be available to provide the assistance during the time when the user making the servicer request can benefit from the assistance. For example, the pairing module 330 may determine whether a start time (or end time) of the offered assistance matches a start time (or end time) of the requested service. For instance, the pairing module 330 may match a request for item delivery by 10 am with an assistance offer from a volunteer who wants to help before 11 am, but not match the request for item delivery with an assistance offer from a volunteer who wants to help before 9 am. As another example, the pairing module 330 may determine whether the duration of time of the offered assistance is no less than the duration of time of the request services. For instance, the pairing module 330 may match a request for a ride service with a travelling time of 20 minutes with an assistance offer indicating that the volunteer has one free hour to help.

In some embodiments, the pairing module 330 may identify an assistance offer (or multiple assistance offers) for the service request based on the spatial information of the assistance offer and the spatial information of the service request. The pairing module 330 may determine whether a location (or locations) where the user making the assistance offer can be available to provide the assistance matches a location (or locations) where the user making the service request can benefit from the assistance. In an embodiment, the pairing module 330 may determine whether a location of the user making the assistance offer is the same or similar as a location of the user making the service request. For instance, the pairing module 330 may determine whether the location of the request service is in the same city as the user making the assistance offer. Additionally or alternatively, the pairing module 330 may determine whether the distance associated with the assistance offer is no less than a distance associated with the service request. In an example, the pairing module 330 may match a request for a ride service with a travelling distance of 10 miles with an assistance offer indicating that the volunteer can help for up to 20 miles. In another example, the pairing module 330 may match a request for a ride service with a travelling distance of 10 miles with an assistance offer to donate 20 miles of AV mileage.

In some embodiments, the pairing module 330 may pair assistance offers with service requests by using a machine learning model. The pairing module 330 may information associated with an assistance offer and information associated with a service request into the machine learning model, and the machine learning model outputs a determine whether to pair the assistance offer with the service request. The pairing module 330 may include or be associated with a training module that trains the model with machine learning techniques. As part of the generation of the model, the training module may form a training set. The training set may include training samples and ground-truth labels of the training samples. A training sample may include information associated with an assistance offer and information associated with a service request. The training sample may have a ground-truth label indicating whether the assistance offer should be paired with the service request. The training module extracts feature values from the training set, the features being variables deemed potentially relevant to classification of assistance offers. In one embodiment, the training module applies dimensionality reduction (e.g., via LDA, PCA, or the like) to reduce the amount of data in the feature vectors for ride services to a smaller, more representative set of data. The training module may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

The vehicle selection module 340 selects AVs for service requests, including service requests paired with assistance offers. The vehicle selection module 340 may select one or more AVs for a service request based on information associated with the service request and information associated with the assistance offer(s) paired with the service request. In some embodiments, the vehicle selection module 340 may select an AV for a service request based on the availability of the AV and temporal information or spatial information of the service request and the assistance offer. For instance, the vehicle selection module 340 may select an AV from the fleet of AV managed by the fleet management system 120 based on one or more times or one or more locations that the AV would be available and one or more times or one or more locations that the requested service or offered assistance would be provided.

In some embodiments, the vehicle selection module 340 may select an AV for a service request paired with an assistance offer based on a determination that the AV includes or is otherwise associated with functions that can support the requested service or offered assistance. The functions may include hardware components, software function, free space, internal configuration, other types of functions, or some combination thereof. In an example, for a ride service request made by a blood donation organization to provide rides to volunteers donating blood, the vehicle selection module 340 may select an AV that can facilitate blood collection supplies. The vehicle selection module 340 may also determine that the AV can navigate to the location of the volunteer at the time that the volunteer would be available. In another example, for a ride service request that is made by a user with wheelchair and can be facilitated by a volunteer helping the user to get on or off AV, the vehicle selection module 340 may select an AV that can fit wheelchairs.

The vehicle dispatch module 350 dispatches AVs to perform service requests, including service requests paired with assistance offers. To dispatch an AV to perform a service request paired with one or more assistance offers, the vehicle dispatch module 350 may plan an operation of the AV based on the service request and the assistance offer(s). The operation plan may include a start time and end time of the AV operation. The vehicle dispatch module 350 may determine the start time or end time based on temporal information of the service request or assistance offer. In some embodiments, the start time or end time may be specified in the service request or assistance offer. In other embodiments, the vehicle dispatch module 350 may infer the start time or end time based on the service request or assistance offer, e.g., based on availability of the user making the assistance offer.

The operation plan may also include a navigation route of the AV based on the service request and the assistance offer(s). The vehicle dispatch module 350 may determine the navigation route based on the spatial information of the service request and the assistance offer(s), such as locations associated with the service request and the assistance offer(s). The navigation route may include locations for picking up or dropping off the user making the service request or the user making the assistance offer. The vehicle dispatch module 350 may determine a sequence of the AV reaching such locations based on the service request and the assistance offer. In an example where a volunteer will help a disabled user to get on and off the AV, the vehicle dispatch module 350 may make the location to pick up the volunteer as the first destination for the AV, followed by the location to pick up the disabled user, further followed by the location to drop off the disabled user and the location to drop off the volunteer as the final destination of the AV's operation.

In some embodiments, the vehicle dispatch module 350 may generate messages for informing the paired users with the operation plan. In some embodiments, a message to a user requesting service may include an option for the user to accept or reject the assistance offered by the other user. Additionally or alternatively, a message to a user requesting service may have a list of assistance offers paired with the service request by the pairing module 330. The message may also include an option for the user to select one or more of the listed assistance offers. The message may further include information about the assistance offer or about the user making the assistance offer, such as available time, available location, scope of assistance, rating on the user making the assistance offer, and so on. A message to a user offering assistance may include an option for the user to say yes or no for assisting with the service requested by the other user. Messages to users may be transmitted to client devices (e.g., client devices 130) associated with the users, e.g., through the client device interface 220. The messages may be displayed in UIs running on the client devices. The users may provide their responses through the UIs. The vehicle dispatch module 350 may receive the users' responses, e.g., through the client device interface 220. In embodiments where both users have accepted the operation plan, the vehicle dispatch module 350 may dispatch the AV for performing the requested service with the offered assistance.

In embodiments where the user offering the assistance rejected the operation plan or does not respond to the message, the vehicle dispatch module 350 may instruct the pairing module 330 to pair the user requesting the service with a different user who has offered assistance. In embodiments where the user requesting the service rejected the operation plan or does not respond to the message, the vehicle dispatch module 350 may determine that the user requesting the service would not need assistance based on the user's response (or lack of response) and may dispatch the AV for performing the service without any voluntary assistance. In some embodiments (e.g., embodiments where the service request module 310, assistance offer module 320, or pairing module 330 uses a trained model), the vehicle dispatch module 350 may provide user responses to the service request module 310, assistance offer module 320, or pairing module 330. The user responses may be used for further training the model used by the service request module 310, assistance offer module 320, or pairing module 330. For instance, the training module may generate a new training sample with the information of the service request or the assistance offer and determine a ground-truth label for the new training sample based on the user response(s). The new training sample and ground-truth label can be used to further train the model.

The vehicle dispatch module 350 may generate a dispatch instruction including the operation plan and transmit the dispatch instruction to the AV. The AV, after receiving the dispatch instruction, will operate in accordance with the dispatch instruction. After the AV completes the operation, the AV may confirm the completion of the operation with the vehicle dispatch module 350. In some embodiments, the vehicle dispatch module 350 may update a status of the service request or the status of the assistance offer after the dispatch instruction is sent to the AV or after the completion confirmation is received. For example, the vehicle dispatch module 350 may mark a service request as processed after it sends out the dispatch instruction or mark the service request as completed after it receives the completion confirmation. As another example, the vehicle dispatch module 350 may change the status of an assistance offer from active to inactive after the service request paired with the assistance offer has been processed or completed. Alternatively, the vehicle dispatch module 350 may keep the assistance offer active but update the scope of the assistance offer. In an example of an assistance offer that provides free AV mileage and specifies a total number of miles, the vehicle dispatch module 350 may update the available AV mileage with a new AV mileage determined by deducting the miles travelled by the AV for performing the service request from the total number of miles. The new AV mileage can be used to facilitate future service requests.

In some embodiments, after an AV service facilitated with human assistance is finished, the vehicle dispatch module 350 may generate one or more messages querying the experience of the user who has received the AV service or the volunteer who has provided the assistance. For example, the vehicle dispatch module 350 may send out a message to query whether a user is satisfied with the AV service or the human assistance. The message may include an option for the user to rate the AV service or the human assistance. As another example, the vehicle dispatch module 350 may send out a message to query whether a volunteer is satisfied with the integration of the volunteering experience with the AV operation. The message may include an option for the volunteer to rate the experience.

### Example Sensor Suite

FIG. 4 is a block diagram showing the sensor suite 140, according to some embodiments of the present disclosure. The sensor suite 140 may be an onboard sensor suite of an AV, e.g., AV 110 in FIG. 1. The sensor suite 140 includes exterior sensors 410, a LIDAR sensor 420, a RADAR sensor 430, and interior sensors 440. The sensor suite 140 may include any number of the types of sensors shown in FIG. 4, e.g., one or more LIDAR sensors 420, one or more RADAR sensors 430, etc. The sensor suite 140 may have more types of sensors than those shown in FIG. 4, such as the sensors described with respect to FIG. 1. In other embodiments, the sensor suite 140 may not include one or more of the sensors shown in FIG. 4.

The exterior sensors 410 may detect objects in an environment around the AV. The environment may include a scene in which the AV operates. Example objects include objects related to weather (e.g., fog, rain, snow, haze, etc.), persons, buildings, traffic cones, traffic lights, traffic signs, barriers, vehicles, street signs, trees, plants, animals, or other types of objects that may be present in the environment around the AV. In some embodiments, the exterior sensors 410 include exterior cameras having different views, e.g., a front-facing camera, a back-facing camera, and side-facing cameras. One or more exterior sensors 410 may be implemented using a high-resolution imager with a fixed mounting and field of view. One or more exterior sensors 410 may have adjustable field of views and/or adjustable zooms.

In some embodiments, the exterior sensors 410 may operate continually during operation of the AV. In an example embodiment, the exterior sensors 410 capture sensor data (e.g., images, etc.) of a scene in which the AV drives. In another embodiment, the exterior sensors 410 may operate in accordance with an instruction from the onboard computer 150 or an external system, such as the vehicle manager 260 of the fleet management system 120. For instance, the onboard computer 150 or vehicle manager 260 may request the exterior sensors 410 to detect environmental features and to generate sensor data that can be used for detecting or predicting environmental conditions. Some of all of the exterior sensors 410 may capture sensor data of one or more objects in an environment surrounding the AV based on the instruction.

The LIDAR sensor 420 may measure distances to objects in the vicinity of the AV using reflected laser light. The LIDAR sensor 420 may be a scanning LIDAR that provides a point cloud of the region scanned. The LIDAR sensor 420 may have a fixed field of view or a dynamically configurable field of view. The LIDAR sensor 420 may produce a point cloud that describes, among other things, distances to various objects in the environment of the AV.

The RADAR sensor 430 may measure ranges and speeds of objects in the vicinity of the AV using reflected radio waves. The RADAR sensor 430 may be implemented using a scanning RADAR with a fixed field of view or a dynamically configurable field of view. The RADAR sensor 430 may include one or more articulating RADAR sensors, long-range RADAR sensors, short-range RADAR sensors, or some combination thereof.

The interior sensors 440 may detect the interior of the AV, such as objects inside the AV. Example objects inside the AV include items delivered by the AV, passengers, client devices of passengers, components of the AV, items facilitating services provided by the AV, and so on. The interior sensors 440 may include multiple interior cameras to capture different views, e.g., to capture views of an object inside the AV. The interior sensors 440 may be implemented with a fixed mounting and fixed field of view, or the interior sensors 440 may have adjustable field of views and/or adjustable zooms, e.g., to focus on one or more interior features of the AV. The interior sensors 440 may also include one or more weight sensors, such as weight transducers, that can measure weights of items delivered by the AV.

In some embodiments, the interior sensors 440 may operate continually during operation of the AV. In an example embodiment, the interior sensors 440 capture sensor data (e.g., images, etc.) of one or more items delivered by the AV. In other embodiment, the interior sensors 440 may operate in accordance with an instruction from the onboard computer 150 or an external system, such as the vehicle manager 260 of the fleet management system 120.

In some embodiments, the interior sensors 440 include one or more input sensors that allow passengers to provide input. For instance, a passenger may use an input sensor to provide feedback on AV behaviors during the ride. The input sensors may include touch screen, microphone, keyboard, mouse, or other types of input devices. In an example, the interior sensors 440 include a touch screen that is controlled by the onboard computer 150. The onboard computer 150 may present messages on the touch screen and receive interaction of the passenger with the messages through the touch screen. A message may include information of one or more undesirable AV behaviors in the ride. In some embodiments, some or all of the interior sensors 440 may operate continually during operation of the AV. In other embodiment, some or all of the interior sensors 440 may operate in accordance with an instruction from the onboard computer 150 or an external system, such as the fleet management system 120.

### Example Onboard Computer

FIG. 5 is a block diagram showing the onboard computer 150 according to some embodiments of the present disclosure. The onboard computer 150 may control an AV, e.g., AV 110 in FIG. 1. As shown in FIG. 5, the onboard computer 150 includes an AV datastore 510, a sensor interface 520, a perception module 530, a control module 540, a control model 550, and a record module 560. In alternative configurations, fewer, different and/or additional components may be included in the onboard computer 150. For example, the onboard computer 150 may include more than one control model 550. As another example, components and modules for conducting route planning, controlling movements of the AV, and other vehicle functions are not shown in FIG. 5. Further, functionality attributed to one component of the onboard computer 150 may be accomplished by a different component included in the onboard computer 150 or a different system, such as the fleet management system 120.

The AV datastore 510 stores data associated with operations of the AV. The AV datastore 510 may store one or more operation records of the AV. An operation record is a record of an operation of the AV, e.g., an operation for providing a ride service. The operation may be a currently performed operation or a previously performed operation (“previous operation” or “historical operation”). The operation record may include information indicating operational behaviors of the AV during the operation. The operational behaviors may include sensor detection, movement, stop, battery charging, calibration, maintenance, communication with the fleet management system 120, communication with assistance agent, communication with user, communication with another AV, and so on. The operations record may also include data used, received, or captured by the AV during the operation, such as map data, instructions from the fleet management system 120, sensor data captured by the AV's sensor suite, and so on. In some embodiments, the AV datastore 510 stores a detailed map that includes a current environment of the AV. The AV datastore 510 may store data in the map datastore 250. In some embodiments, the AV datastore 510 stores a subset of the map datastore 250, e.g., map data for a city or region in which the AV is located.

The data in the AV datastore 510 may include data generated by the AV itself. The data may include sensor data capturing one or more environments where the AV operates, e.g., operates to provide services. The sensor data may be from the sensor suite 140 of the AV. The data in the AV datastore 510 may also include perception data that identifies one or more environmental conditions. The perfection data may be from the perception module 530 of the onboard computer 150 of the AV. The data may also include external data, e.g., data from other AVs or systems. For example, the data in the AV datastore 510 may include data (e.g., sensor data, perception, etc.) from one or more other AVs that capture one or more environments where the other AVs operate. As another example, the data in the AV datastore 510 may include data from the fleet management system 120, e.g., data about environmental conditions, instructions (e.g., operational plans) from the vehicle manager 260, etc. In yet another example, the data in the AV datastore 510 may include data from one or more third-party systems that provide information of environments where the AV operates. The AV may be in communication with the one or more third-party systems, e.g., through a network.

The sensor interface 520 interfaces with the sensors in the sensor suite 140. The sensor interface 520 may request data from the sensor suite 140, e.g., by requesting that a sensor capture data in a particular direction or at a particular time. For example, the sensor interface 520 instructs the sensor suite 140 to capture sensor data of an environment surrounding the AV, e.g., by sending a request for sensor data to the sensor suite 140. In some embodiments, the request for sensor data may specify which sensor(s) in the sensor suite 140 to provide the sensor data, and the sensor interface 520 may request the sensor(s) to capture data. The request may further provide one or more settings of a sensor, such as orientation, resolution, accuracy, focal length, and so on. The sensor interface 520 can request the sensor to capture data in accordance with the one or more settings.

A request for sensor data may be a request for real-time sensor data, and the sensor interface 520 can instruct the sensor suite 140 to immediately capture the sensor data and to immediately send the sensor data to the sensor interface 520. The sensor interface 520 is configured to receive data captured by sensors of the sensor suite 140, including data from exterior sensors mounted to the outside of the AV, and data from interior sensors mounted in the passenger compartment of the AV. The sensor interface 520 may have subcomponents for interfacing with individual sensors or groups of sensors of the sensor suite 140, such as a camera interface, a LIDAR interface, a RADAR interface, a microphone interface, etc.

The perception module 530 identifies objects and/or other features captured by the sensors of the AV. The perception module 530 may identify objects inside the AV based on sensor data captured by one or more interior sensors (e.g., the interior sensors 440). For instance, the perception module 530 may identify one or more passengers in the AV. In some embodiments, the perception module 530 identifies objects in the environment of the AV and captured by one or more sensors (e.g., the exterior sensors 410, LIDAR sensor 420, RADAR sensor 430, etc.). As another example, the perception module 530 determines one or more environmental conditions based on sensor data from one or more sensors (e.g., the exterior sensors 410, LIDAR sensor 420, RADAR sensor 430, etc.).

The perception module 530 may include one or more classifiers trained using machine learning to identify particular objects. For example, a multi-class classifier may be used to classify each object in the AV or in the environment of the AV as one of a set of potential objects, e.g., a passenger, a vehicle, a pedestrian, or a cyclist. As another example, a passenger classifier recognizes passengers in the AV, a pedestrian classifier recognizes pedestrians in the environment of the AV, a vehicle classifier recognizes vehicles in the environment of the AV, etc. The perception module 530 may identify facial expressions of people, such as passengers, e.g., based on data from interior cameras. The perception module 530 may identify travel speeds of identified objects based on data from the RADAR sensor 430, e.g., speeds at which other vehicles, pedestrians, or birds are travelling. As another example, the perception module 53—may identify distances to identified objects based on data (e.g., a captured point cloud) from the LIDAR sensor 420, e.g., a distance to a particular vehicle, building, or other feature identified by the perception module 530. The perception module 530 may also identify other features or characteristics of objects in the environment of the AV based on image data or other sensor data, e.g., colors (e.g., the colors of winter holiday lights), sizes (e.g., heights of people or buildings in the environment), makes and models of vehicles, pictures and/or words on billboards, etc.

In some embodiments, the perception module 530 fuses data from one or more interior sensors 440 with data from exterior sensors (e.g., exterior sensors 410) and/or AV datastore 510 to identify environmental objects that one or more users are looking at. The perception module 530 determines, based on an image of a user, a direction in which the user is looking, e.g., a vector extending from the user and out of the AV in a particular direction. The perception module 530 compares this vector to data describing features in the environment of the AV, including the features' relative location to the AV (e.g., based on real-time data from exterior sensors and/or the AV's real-time location) to identify a feature in the environment that the user is looking at.

While a single perception module 530 is shown in FIG. 5, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 540 controls operations of the AV, e.g., based on information from the sensor interface 520 or the perception module 530. In some embodiments, the control module 540 controls operation of the AV by using the control model 550. The control model 550 may be trained and selected by the vehicle manager 260. Even though FIG. 5 shows a single control model, the control module 540 may use multiple control models to control operations of the AV. The control model 550 may be updated or replaced by one or more new control models over time.

The control module 540 may provide input data to the control model 550, and the control model 550 outputs operation parameters for the AV. The input data may include sensor data from the sensor interface 520 (which may indicate a current state of the AV), objects identified by the perception module 530, data from the fleet management system 120, other data, or some combination thereof. The operation parameters are parameters indicating operation to be performed by the AV. The operation of the AV may include perception, prediction, planning, localization, motion, navigation, other types of operation, or some combination thereof.

The control module 540 may provide instructions to various components of the AV based on the output of the control model, and these components of the AV will operate in accordance with the instructions. In an example where the output of the control model indicates that a change of travelling speed of the AV is required given a prediction of traffic condition, the control module 540 may instruct the motor of the AV to change the travelling speed of the AV. In another example where the output of the control model indicates a need to detect characteristics of an object in the environment around the AV (e.g., detect a speed limit), the control module 540 may instruct the sensor suite 140 to capture an image of the speed limit sign with sufficient resolution to read the speed limit and instruct the perception module 530 to identify the speed limit in the image.

The record module 560 generates operation records of the AV and stores the operations records in the AV datastore 510. The record module 560 may generate an operation record in accordance with an instruction from the fleet management system 120, e.g., the vehicle manager 260. The instruction may specify data to be included in the operation record. The record module 560 may determine one or more timestamps for an operation record. In an example of an operation record for a ride service, the record module 560 may generate timestamps indicating the time when the ride service starts, the time when the ride service ends, times of specific AV behaviors associated with the ride service, and so on. The record module 560 can transmit the operation record to the fleet management system 120.

Example Method of Integrating Volunteering with AV Operations

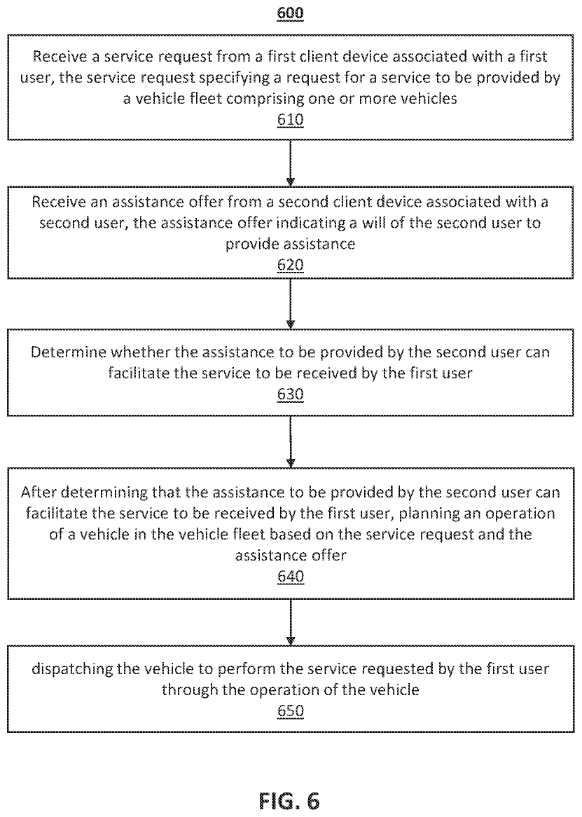

FIG. 6 is a flowchart showing a method 600 of integrating volunteering with AV operations, according to some embodiments of the present disclosure. The method 600 may be performed by the vehicle manager 260. Although the method 600 is described with reference to the flowchart illustrated in FIG. 6, many other methods of integrating volunteering with AV operations may alternatively be used. For example, the order of execution of the steps in FIG. 6 may be changed. As another example, some of the steps may be changed, eliminated, or combined.

The vehicle manager 260 receives 610 a service request from a first client device associated with a first user. The service request specifies a request for a service to be provided by a vehicle fleet comprising one or more vehicles. The first user may be an individual or organization. In some embodiments, the first user or a member of the first user may have one or more skill sets or capabilities, due to which the first user may benefit from human assistance associated with AV services. The one or more vehicles may be AVs, such as AVs 110.

The vehicle manager 260 receives 620 an assistance offer from a second client device associated with a second user. The assistance offer indicates a will of the second user to provide assistance. The second user may be a person or organization that wants to volunteer, e.g., to give time and labor for community service. The second user may also be a person or organization that wants to donate AV mileage, money, goods, blood, and so on.

The vehicle manager 260 determines 630 whether the assistance to be provided by the second user can facilitate the service to be received by the first user. In some embodiments, the vehicle manager 260 may match the first user with the second user based on the service request from the first user and the assistance offer from the second user. In an example, the vehicle manager 260 determines whether a mileage indicated in the assistance offer is no less than a mileage indicated in the service request. As another example, the vehicle manager 260 determines whether the assistance to be provided by the second user can facilitate the service to be received by the first user based on one or times indicated in the service request and one or more times indicated in the assistance offer.

In some embodiments, the vehicle manager 260 selects the first user from a plurality of users based on the assistance offer and one or more attributes of the first user. In some embodiments, the vehicle manager 260 selects the second user from a plurality of users based on the service request.

The vehicle manager 260 plans 640 an operation of a vehicle in the vehicle fleet based on the service request and the assistance offer after determining that the assistance to be provided by the second user can facilitate the service to be received by the first user. In some embodiments, the vehicle manager 260 determines a navigation route of the vehicle based on one or more locations indicated in the assistance offer.

The vehicle manager 260 dispatches 650 the vehicle to perform the service requested by the first user through the operation of the vehicle. The first user or the second user is a passenger of the vehicle during at least part of the operation of the vehicle.

In some embodiments, the vehicle manager 260 generates a message comprising information indicating the assistance to be provided by the second user and sends the message to the first client device. In some embodiments, the message further comprises an option for the first user to accept or decline the assistance to be provided by the second user.

### SELECT EXAMPLES

Example 1 provides a method, including receiving a service request from a first client device associated with a first user, the service request specifying a request for a service to be provided by a vehicle fleet including one or more vehicles; receiving an assistance offer from a second client device associated with a second user, the assistance offer indicating a will of the second user to provide assistance; determining whether the assistance to be provided by the second user can facilitate the service to be received by the first user; after determining that the assistance to be provided by the second user can facilitate the service to be received by the first user, planning an operation of a vehicle in the vehicle fleet based on the service request and the assistance offer; and dispatching the vehicle to perform the service requested by the first user through the operation of the vehicle.

Example 2 provides the method of example 1, where determining whether the assistance to be provided by the second user can facilitate the service to be received by the first user includes determining whether a mileage indicated in the assistance offer is no less than a mileage indicated in the service request.

Example 3 provides the method of example 1 or 2, where determining whether the assistance to be provided by the second user can facilitate the service to be received by the first user includes determining whether the assistance to be provided by the second user can facilitate the service to be received by the first user based on one or times indicated in the service request and one or more times indicated in the assistance offer.

Example 4 provides the method of any of the preceding examples, where planning the operation of the vehicle in the vehicle fleet includes determining a navigation route of the vehicle based on one or more locations indicated in the assistance offer.

Example 5 provides the method of any of the preceding examples, further including selecting the first user from a plurality of users based on the assistance offer and one or more attributes of the first user.

Example 6 provides the method of any of the preceding examples, further including selecting the second user from a plurality of users based on the service request.

Example 7 provides the method of any of the preceding examples, further including selecting the vehicle from the vehicle fleet based on one or more components of the vehicle and one or more attributes of the first user.

Example 8 provides the method of any of the preceding examples, further including generating a message including information indicating the assistance to be provided by the second user; and sending the message to the first client device.

Example 9 provides the method of example 8, where the message further includes an option for the first user to accept or decline the assistance to be provided by the second user.

Example 10 provides the method of any of the preceding examples, where the first user or the second user is a passenger of the vehicle during at least part of the operation of the vehicle.

Example 11 provides one or more non-transitory computer-readable media storing instructions executable to perform operations, the operations including receiving a service request from a first client device associated with a first user, the service request specifying a request for a service to be provided by a vehicle fleet including one or more vehicles; receiving an assistance offer from a second client device associated with a second user, the assistance offer indicating a will of the second user to provide assistance; determining whether the assistance to be provided by the second user can facilitate the service to be received by the first user; after determining that the assistance to be provided by the second user can facilitate the service to be received by the first user, planning an operation of a vehicle in the vehicle fleet based on the service request and the assistance offer; and dispatching the vehicle to perform the service requested by the first user through the operation of the vehicle.

Example 12 provides the one or more non-transitory computer-readable media of example 11, where determining whether the assistance to be provided by the second user can facilitate the service to be received by the first user includes determining whether a mileage indicated in the assistance offer is no less than a mileage indicated in the service request.

Example 13 provides the one or more non-transitory computer-readable media of example 11 or 12, where determining whether the assistance to be provided by the second user can facilitate the service to be received by the first user includes determining whether the assistance to be provided by the second user can facilitate the service to be received by the first user based on one or times indicated in the service request and one or more times indicated in the assistance offer.

Example 14 provides the one or more non-transitory computer-readable media of any one of examples 11-13, where planning the operation of the vehicle in the vehicle fleet includes determining a navigation route of the vehicle based on one or more locations indicated in the assistance offer.

Example 15 provides the one or more non-transitory computer-readable media of any one of examples 11-14, where the operations further include selecting the first user or the second user from a plurality of users based on the service request and the assistance offer.

Example 16 provides the one or more non-transitory computer-readable media of any one of examples 11-15, where the operations further include selecting the vehicle from the vehicle fleet based on one or more components of the vehicle and one or more attributes of the first user.

Example 17 provides the one or more non-transitory computer-readable media of any one of examples 11-16, where the operations further include generating a message including information indicating the assistance to be provided by the second user; and sending the message to the first client device.

Example 18. A computer system, including a computer processor for executing computer program instructions; and one or more non-transitory computer-readable media storing computer program instructions executable by the computer processor to perform operations including receiving a service request from a first client device associated with a first user, the service request specifying a request for a service to be provided by a vehicle fleet including one or more vehicles, receiving an assistance offer from a second client device associated with a second user, the assistance offer indicating a will of the second user to provide assistance, determining whether the assistance to be provided by the second user can facilitate the service to be received by the first user, after determining that the assistance to be provided by the second user can facilitate the service to be received by the first user, planning an operation of a vehicle in the vehicle fleet based on the service request and the assistance offer, and dispatching the vehicle to perform the service requested by the first user through the operation of the vehicle.

Example 19 provides the computer system of example 18, where determining whether the assistance to be provided by the second user can facilitate the service to be received by the first user includes determining whether a mileage indicated in the assistance offer is no less than a mileage indicated in the service request.

Example 20 provides the computer system of example 18 or 19, where determining whether the assistance to be provided by the second user can facilitate the service to be received by the first user includes determining whether a mileage indicated in the assistance offer is no less than a mileage indicated in the service request.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
receiving a service request from a first client device associated with a first user, the service request specifying a request for a service to be provided by a vehicle fleet comprising one or more vehicles;
receiving an assistance offer from a second client device associated with a second user, the assistance offer indicating a will of the second user to provide assistance;
determining whether the assistance to be provided by the second user can facilitate the service to be received by the first user;
after determining that the assistance to be provided by the second user can facilitate the service to be received by the first user, planning an operation of a vehicle in the vehicle fleet based on the service request and the assistance offer; and
dispatching the vehicle to perform the service requested by the first user through the operation of the vehicle.

2. The method of claim 1, wherein determining whether the assistance to be provided by the second user can facilitate the service to be received by the first user comprises:
determining whether a mileage indicated in the assistance offer is no less than a mileage indicated in the service request.

3. The method of claim 1, wherein determining whether the assistance to be provided by the second user can facilitate the service to be received by the first user comprises:
determining whether the assistance to be provided by the second user can facilitate the service to be received by the first user based on one or times indicated in the service request and one or more times indicated in the assistance offer.

4. The method of claim 1, wherein planning the operation of the vehicle in the vehicle fleet comprises:
determining a navigation route of the vehicle based on one or more locations indicated in the assistance offer.

5. The method of claim 1, further comprising:
selecting the first user from a plurality of users based on the assistance offer and one or more attributes of the first user.

6. The method of claim 1, further comprising:
selecting the second user from a plurality of users based on the service request.

7. The method of claim 1, further comprising:
selecting the vehicle from the vehicle fleet based on one or more components of the vehicle and one or more attributes of the first user.

8. The method of claim 1, further comprising:
generating a message comprising information indicating the assistance to be provided by the second user; and
sending the message to the first client device.

9. The method of claim 8, wherein the message further comprises an option for the first user to accept or decline the assistance to be provided by the second user.

10. The method of claim 1, wherein the first user or the second user is a passenger of the vehicle during at least part of the operation of the vehicle.

11. One or more non-transitory computer-readable media storing instructions executable to perform operations, the operations comprising:
receiving a service request from a first client device associated with a first user, the service request specifying a request for a service to be provided by a vehicle fleet comprising one or more vehicles;
receiving an assistance offer from a second client device associated with a second user, the assistance offer indicating a will of the second user to provide assistance;
determining whether the assistance to be provided by the second user can facilitate the service to be received by the first user;
after determining that the assistance to be provided by the second user can facilitate the service to be received by the first user, planning an operation of a vehicle in the vehicle fleet based on the service request and the assistance offer; and
dispatching the vehicle to perform the service requested by the first user through the operation of the vehicle.

12. The one or more non-transitory computer-readable media of claim 11, wherein determining whether the assistance to be provided by the second user can facilitate the service to be received by the first user comprises:
determining whether a mileage indicated in the assistance offer is no less than a mileage indicated in the service request.

13. The one or more non-transitory computer-readable media of claim 11, wherein determining whether the assistance to be provided by the second user can facilitate the service to be received by the first user comprises:
determining whether the assistance to be provided by the second user can facilitate the service to be received by the first user based on one or times indicated in the service request and one or more times indicated in the assistance offer.

14. The one or more non-transitory computer-readable media of claim 11, wherein planning the operation of the vehicle in the vehicle fleet comprises:
determining a navigation route of the vehicle based on one or more locations indicated in the assistance offer.

15. The one or more non-transitory computer-readable media of claim 11, wherein the operations further comprise:
selecting the first user or the second user from a plurality of users based on the service request and the assistance offer.

16. The one or more non-transitory computer-readable media of claim 11, wherein the operations further comprise:
selecting the vehicle from the vehicle fleet based on one or more components of the vehicle and one or more attributes of the first user.

17. The one or more non-transitory computer-readable media of claim 11, wherein the operations further comprise:
generating a message comprising information indicating the assistance to be provided by the second user; and
sending the message to the first client device.

18. A computer system, comprising:
a computer processor for executing computer program instructions; and
one or more non-transitory computer-readable media storing computer program instructions executable by the computer processor to perform operations comprising:
receiving a service request from a first client device associated with a first user, the service request specifying a request for a service to be provided by a vehicle fleet comprising one or more vehicles,
receiving an assistance offer from a second client device associated with a second user, the assistance offer indicating a will of the second user to provide assistance,
determining whether the assistance to be provided by the second user can facilitate the service to be received by the first user,
after determining that the assistance to be provided by the second user can facilitate the service to be received by the first user, planning an operation of a vehicle in the vehicle fleet based on the service request and the assistance offer, and
dispatching the vehicle to perform the service requested by the first user through the operation of the vehicle.

19. The computer system of claim 18, wherein determining whether the assistance to be provided by the second user can facilitate the service to be received by the first user comprises:
determining whether a mileage indicated in the assistance offer is no less than a mileage indicated in the service request.

20. The computer system of claim 18, wherein determining whether the assistance to be provided by the second user can facilitate the service to be received by the first user comprises:
determining whether a mileage indicated in the assistance offer is no less than a mileage indicated in the service request.
